(19) United States
(12) Patent Application Publication
(10) Pub. No.: US 2010/0219344 A1
(43) Pub. Date: Sep. 2, 2010

(54) Electrochemically Modulated Separations for In-line and At-line Monitoring of Actinides in High-Volume Process Streams

(75) Inventors: Douglas C. Duckworth, Richland, WA (US); Judah I. Friese, Kennewick, WA (US); Shane M. Peper, Pasco, WA (US); Matthew Douglas, Richland, WA (US); Jon M. Schwantes, Richland, WA (US); Martin Liezers, Richland, WA (US); Scott A. Lehn, Pearland, TX (US)

Correspondence Address: BATTELLE MEMORIAL INSTITUTE;ATTN: IP SERVICES, K1-53, P. O. BOX 999, RICHLAND, WA, 99352, US

(73) Assignee: Battelle Memorial Institute, Richland, WA (US)

(21) Appl. No.: 12/394,491

(22) Filed: Feb. 27, 2009

(51) Int. Cl. G01T 1/20; G01T 3/00

(52) U.S. Cl. 250/362; 250/390.07

(57) ABSTRACT

Methods for monitoring target actinides in a fuel reprocessing or waste remediation facility. The methods can be characterized by providing a fuel reprocessing or waste remediation stream having at least one target actinide and at least one other radionuclide. At least a portion of the stream is flowed through an electrochemically modulated separations (EMS) device comprising a carbon-based electrode. A potential is applied to the carbon-based electrode to adjust the redox states of the target actinide, at least one of the radionuclides, or both. The target actinide is separated from the other radionuclides through reaction with, or at, the carbon-based electrode. Finally, direct, in-line chemical nondestructive analysis, at-line chemical separations and sampling analysis, or both, of the target actinide is performed.

### PRIORITY

This invention claims priority from U. S. Provisional Patent Application No. 60/______, filed Feb. 29, 2008, by inventors Douglas C. Duckworth, Judah I. Friese, Shane M. Peper, Matthew Douglas, Jon M. Schwantes, Martin Liezers, and Scott A. Lehn (Attorney Docket No. 15926-E PROV). This Provisional Application, entitled “On-line electrochemical separation, concentration, and sampling system and method for destructive and non-destructive radionuclide measurements,” is herein incorporated by reference.

### SPONSORED RESEARCH AND DEVELOPMENT

This invention was made with Government support under Contract DE-AC0576RL01830 awarded by the U.S. Department of Energy. The Government has certain rights in the invention.

### BACKGROUND OF THE INVENTION

The Safeguards community recognizes that an accurate and timely measurement of accountable material mass (e.g., Pu) at the head-end of a facility is critical to a modern materials control and accountability program at fuel reprocessing plants. Ideally, this “input accountancy” value would come from assay of the fissile mass contained in the fuel assemblies themselves, as they enter the facility. However, current fuel non-destructive analysis technologies cannot meet this challenge, at least to the level of accuracy required by international and domestic safeguards. Therefore, samples from the dissolution vessel are generally used to “start the accountancy books.” This destructive analysis of extracted samples can take days to complete and months to verify and represents a technology gap that might be filled by an in-line method to directly measure the mass of accountable materials at the dissolver tank. Similarly, the mass of accountable materials like Pu must be monitored throughout the plant to ensure that the input mass and output mass discrepancies fall within safeguards regulatory bounds. Destructive analysis has thus far been the primary means to achieve this. Measurement of Cm as an indicator of Pu mass, via nondestructive neutron detection, has been proposed as an in-line alternative. The use of a suite of gamma-emitting isotopes for similar purposes has also been suggested. Both options, however, are indirect, confirmatory signatures for accountable materials like Pu, not the direct measurements that are desired.

Additional advantages and novel features of the present invention will be set forth as follows and will be readily apparent from the descriptions and demonstrations set forth herein. Accordingly, the following descriptions of the present invention should be seen as illustrative of the invention and not as limiting in any way.

### SUMMARY

The present invention provides methods and apparatuses for in-line and at-line materials analysis and for chemical separations using electrochemically-modulated separations of actinides from other radionuclides facilitated by carbon electrodes modified by anodization. In traditional electrochemical stripping analysis, voltage applied to a working electrode results in analyte accumulation via reduction or oxidation at the working electrode due to redox selectivity in either accumulation or release processes. Embodiments of the present invention extend the applicability of the stripping analysis approach to intractable elements—elements not readily reduced—via adsorption or complexation of ions in solution with complexing agents or surface functional groups in/on the electrode surface. In this manner, metals can be accumulated by ion-exchange, complexation, and hydrophobic interactions. In addition, embodiments of the present invention can further include the utilization of radiation detectors that provide for additional analysis.

Particular embodiments of the present invention include devices and methods that incorporate electrochemically-modulated separations (EMS) with nondestructive radioassay techniques (e.g. gamma or neutron spectroscopy) in high-volume process streams (e.g., process streams at fuel reprocessing and/or waste remediation facilities) for non-invasive, or minimally invasive, process monitoring and material safeguards accountability analysis of radionuclides. Preferred embodiments can comprise a flow-through electrochemical column in which isolation of U or Pu occurs at anodized carbon-based electrodes as redox states are adjusted with applied potentials. U and Pu can be separated both from one another as well as from other radioisotopes (e.g., activation and fission products) because the targeted redox state allows complexation at, and within, the anodized carbon matrix. The result of this separation is an improved signal-to-background condition allowing for spectroscopic measurements, which are not feasible by traditional methods and systems.

As used herein, in-line chemical separations analysis can refer to isolating and measuring target actinides at the facility and roughly at the time of sampling. Analysis would be non-destructive. Typically, an in-line analysis would involve a measurement device placed into the process line or into a composite sample stream from the process line. Measurements would preferably be relatively rapid and would not involve removing a sample for separate lab analysis. An exemplary application of in-line analysis includes monitoring for acute diversion of materials comprising the target actinide, which monitoring would ideally occur at the facility and would return rapid results.

In contrast, at-line chemical separations analysis can refer to isolating target actinides at the facility, but not necessarily performing analysis at the time and/or place of sampling. Typically, at-line analysis involves a measurement device placed into the process line or into a composite sample stream from the process line. Measurements would preferably be made separate from the process line and can employ destructive analysis to prioritize accuracy, precision, and/or sensitivity over speed of measurement and/or rapid results.

The EMS enabled at-line and in-line analyses of the present invention differ from traditional in-lab analysis at least in that they involve much higher throughput and occur in complex, real-world process-stream compositions.

Accordingly, embodiments of the present invention can encompass monitoring target actinides in a fuel reprocessing or waste remediation facility by utilizing an EMS device for separations and by performing direct, in-line, chemical, non-destructive analysis, at-line chemical separations and sampling analysis, or both. In one example, a flow-through electrochemical cell is utilized to isolate a target actinide at an anodized carbon-based electrode as redox states are adjusted with applied potentials. The target actinide can be separated both from other actinides as well as from other radioisotopes because the targeted redox state allows complexation at, and within, the anodized carbon matrix. Gamma spectroscopy can be performed in-line. Alternatively, gamma spectroscopy and/or other destructive analyses can be performed at-line.

In a specific example, an in-line process monitoring device can be highly selective for Pu(VI) at positive accumulations potentials (e.g., greater than +0.8V) or U(IV) at slightly negative potentials (e.g., approximately −0.15V). The redox process is reversible, so after measurement, these both can be efficiently released from the surface and back into the process stream. Various detection systems can be integrated with the monitoring device for other measurements. Throughput is primarily dependent on counting periods, but numerous process measurements can be possible each day. Counting periods will depend on the amount of material accumulated in a given time. The amount of accumulation will be dependent on surface area and mass throughput. In a preferred embodiment, measurements occur at a rate of at least once per hour.

Much of the proof-of-concept has been performed on the lab scale. Experimentally determined decontamination factors were measured using a low volume EMS cell for accumulation of Pu from a simulated PWR, 10-year-cooled reactor fuel. Measured decontamination factors were used to model gamma spectroscopy results. In this model, continuum background was reduced 1000-fold and indicated that direct measurements of Pu in the dissolver solution are possible using non-invasive measurements.

In a preferred embodiment of the invention, an EMS device is modified to have a high mass-throughput and a high surface area carbon-based electrode. In a particular example, the EMS cell has an active carbon surface area greater than 5 cm². The high throughput and high selectivity enable the subsequent in-line and at-line analyses of the present invention. Accordingly, in some embodiments, the target actinide comprises Pu, the stream comprises fission products, actinide products and greater than 0.1% dissolved solids, and the separations results in a greater than 95% retention of Pu. In other embodiments, the target actinide is separated from the stream while the other radionuclides, which can comprise ¹³⁷Cs, ^{137m}Ba, or ^{154,155}Eu, are rejected at a rejection factor greater than 98%. In still other embodiments, the target actinide comprises Pu, at least one of the other radionuclides comprises U, and there is greater than 10 million fold excess uranium. In yet another embodiment, at least one of the other radionuclides comprises ¹²⁵Sb, which is rejected at a rejection factor greater than 75%. The EMS separations can be so effective, that in a most preferred embodiment, no other separations steps/processes are performed prior to the direct, in-line chemical nondestructive analysis, the at-line chemical separations and sampling analysis, or both, of the target actinide.

In some at-line embodiments, small (e.g., nanogram) grab samples can be collected for laboratory-based destructive analysis. In practice, the targeted actinide would be accumulated for a short period on the anodized carbon to minimize absolute sample quantity and associated radioactivity, rinsed, and removed for laboratory isotopic and concentration analysis.

The purpose of the foregoing abstract is to enable the United States Patent and Trademark Office and the public generally, especially the scientists, engineers, and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

Various advantages and novel features of the present invention are described herein and will become further readily apparent to those skilled in this art from the following detailed description. In the preceding and following descriptions I have shown and described only the preferred embodiment of the invention, by way of illustration of the best mode contemplated for carrying out the invention. As will be realized, the invention is capable of modification in various respects without departing from the invention. Accordingly, the drawings and description of the preferred embodiment set forth hereafter are to be regarded as illustrative in nature, and not as restrictive.

### DESCRIPTION OF THE DRAWINGS

Embodiments of the invention are described below with reference to the following accompanying drawings.

FIG. 1 is an illustration of an example of an EMS cell utilized by embodiments of the present invention.

FIG. 2 is a signal profile for Pu during EMS showing four typical stages.

FIG. 3 is a signal profile for U following EMS.

FIG. 4 is an illustration depicting an embodiment of in-line and at-line analyses on a process line.

FIGS. 5a and 5b are gamma-ray spectra before and after EMS.

### DESCRIPTION OF THE INVENTION

The following description includes the preferred best mode of one embodiment of the present invention. It will be clear from this description of the invention that the invention is not limited to these illustrated embodiments, but that the invention also includes a variety of modifications and embodiments thereto. Therefore the present description should be seen as illustrative and not limiting. While the invention is susceptible of various modifications and alternative constructions, it should be understood, that there is no intention to limit the invention to the specific form disclosed, but, on the contrary, the invention is to cover all modifications, alternative constructions, and equivalents falling within the spirit and scope of the invention as defined in the claims.

Electrochemically-modulated separations devices of the present invention employ solely aqueous chemistry and use electrochemical redox adjustment of oxidation state to “trigger” reversible chelation/complexation/adsorption. Separation can be achieved by a small voltage step, applied to the target electrode to turn “on” or “off” the specific actinide affinity for an electrode. In embodiments of the present invention, the carbon-based electrodes require chemical modification (i.e., oxidation) of the electrode surface for electrochemical activation via anodization in nitric acid. Other means of anodization should perform equally well (e.g. ozonation), with the key being the formation of oxygen-containing surface moieties.

In specific examples involving U and Pu, separation occurs following redox adjustment of solvated cations in solution. Uranium can be bound to oxygen moieties at the anodized carbon surface, presumably upon adjustment to U(IV). The mechanism for Pu accumulation is still incomplete in our understanding. It appears that Pu(IV) complexes with interstitial anions (nitrate, sulfate) deposited during anodization of the GC. U and Pu analytes are released upon oxidation and reduction, respectively, allowing complete separation due to widely divergent redox potentials.

The ability to effect on/off (i.e., reversible) sequestering of actinides and fission products via electrode redox potential control is an aspect of the present invention and provides capabilities for safeguards testing and process control because it offers the potential for in-line and at-line, near-real-time and most importantly, direct measurement of accountable materials (e.g., target actinides) in the process streams of reprocessing waste remediation facilities.

Exemplary applications include actinide specific sampling of small (ng-sized), purified actinide elements for destructive analysis, as well as purification for non-destructive analysis, free of background radiation in radiochemical measurements. It is very amenable to the reprocessing environment because no organic solvents are required, no solvent switching or matrix conversion is required (nitric acid solutions only), and no redox chemicals such as hydrazine are required. It is a very simple system, using only carbon electrodes, and nitric acid, making it very robust within the harsh (highly turbid) environment. Again, high selectivity arises from a two step process—both oxidation state and surface complexation/adsorption.

Embodiments of the present invention can utilize a number of scenarios for implementation of electrochemically-modulated separation in safeguards including various reprocessing stages and targeted elements. Pu extraction can be used for destructive analysis sampling or non-destructive analysis (isolation and perhaps redox current quantification) at virtually any (aqueous) point along a reprocessing stream. The preconcentration effect of the accumulation from large volumes will provide a sensitive approach for null Pu testing of the low concentration stream and will be applicable to Pu measurements following Pu extractions. Possible due to electrochemical reversibility, the ability to measure a reduction (stripping) current of the selectively isolated Pu, at any point in the stream, would allow a definitive (current measurement based) approach to Pu concentration determination. Anodized carbon has an increased resistance due to oxidation that impedes current measurement as a means of quantification of trace actinides. At higher concentrations, it may be possible to measure the redox current for redox specific actinide (Pu measurements) in-line.

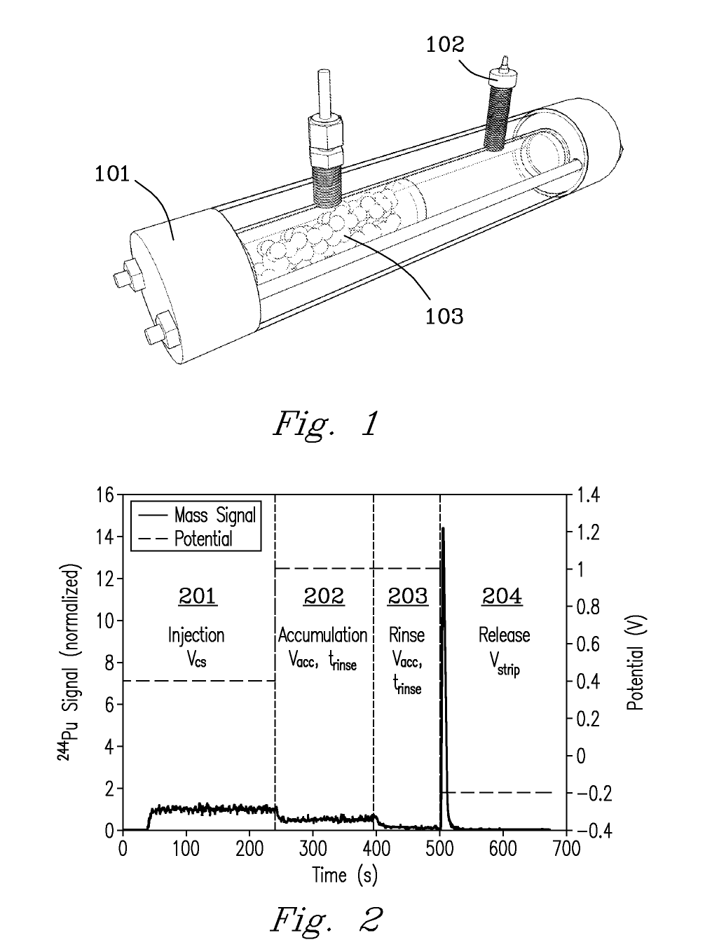

To demonstrate the aspects of the present invention, one can monitor Pu separation via electrochemically-modulated separation coupled on-line with ICP mass spectrometry. The temporal accumulation and release can be observed over the course of a separation. A three-electrode flow-by electrochemical cell was used in this application, though much larger porous graphitic carbon electrodes are envisioned for the safeguards application, allowing gamma-ray spectroscopy (for example) to be applied as the in-line diagnostic technology. Referring to FIG. 1, an embodiment of a large volume cell is shown that consists of a graphite counter-electrode end-cap 101, a reticulated vitreous carbon working electrode 103 within the cell, and a small Ag/AgCl reference electrode 102. For in-line measurements, a gamma or neutron detector can be placed around, or in close proximity, to the carbon working electrode. For at-line measurements, the target actinide can be rinsed off of the working electrode and then collected as a sample to be analyzed separately.

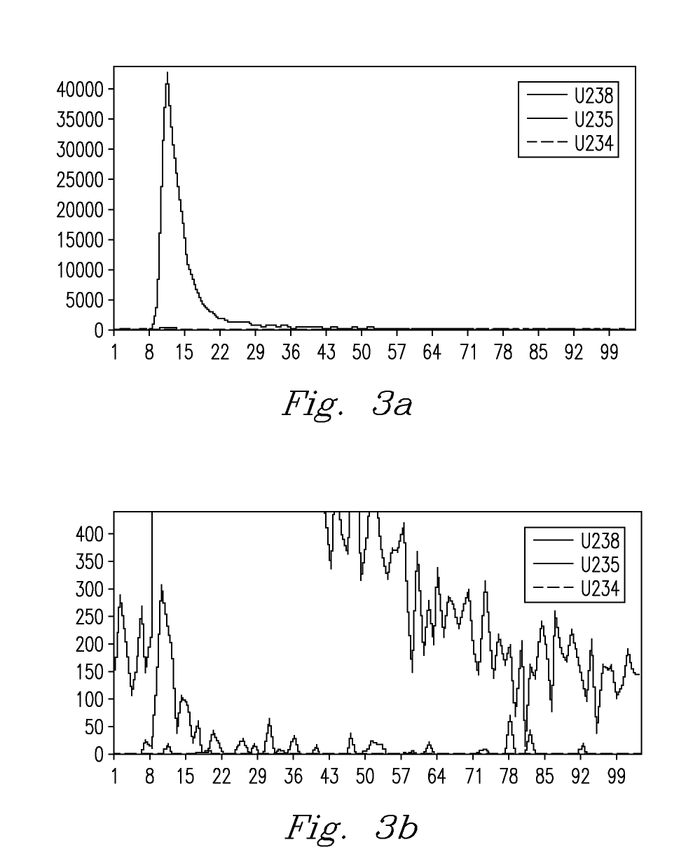

Applying a potential (e.g., +1.8 V) while in the presence of dilute nitric acid can first anodize the carbon electrode. The carbon becomes activated (i.e., anodized) and is ready for use. Referring to FIG. 2, which shows a plot of both the potential and a plutonium mass signal as functions of time, four distinct stages during a typical experiment include injection 201, accumulation 202, rinse 203, and release 204.

A 0.46 M HNO₃ carrier solution flowed through the system and the working electrode potential was set to a value exhibiting no analyte retention (V_{CS}). Pu was injected and the mass spectral signal was allowed to reach a steady-state value (CS). Next, the working electrode potential was stepped to a value resulting in accumulation of the sample (V_{acc}). This was confirmed by a decrease in the steady-state mass spectral deposition signal (DS). After accumulation (t_{acc}) the valve was switched and the system rinsed with nitric acid solution (tᵣᵢₙₛₑ) while holding the electrode at V_{acc}; removing the sample matrix while retaining the sample. The working electrode potential was then stepped to a value that releases the sample into the carrier solution (Vₛₜᵣᵢₚ). The release of accumulated sample in a step-like manner is observed as a transient mass spectral signal.

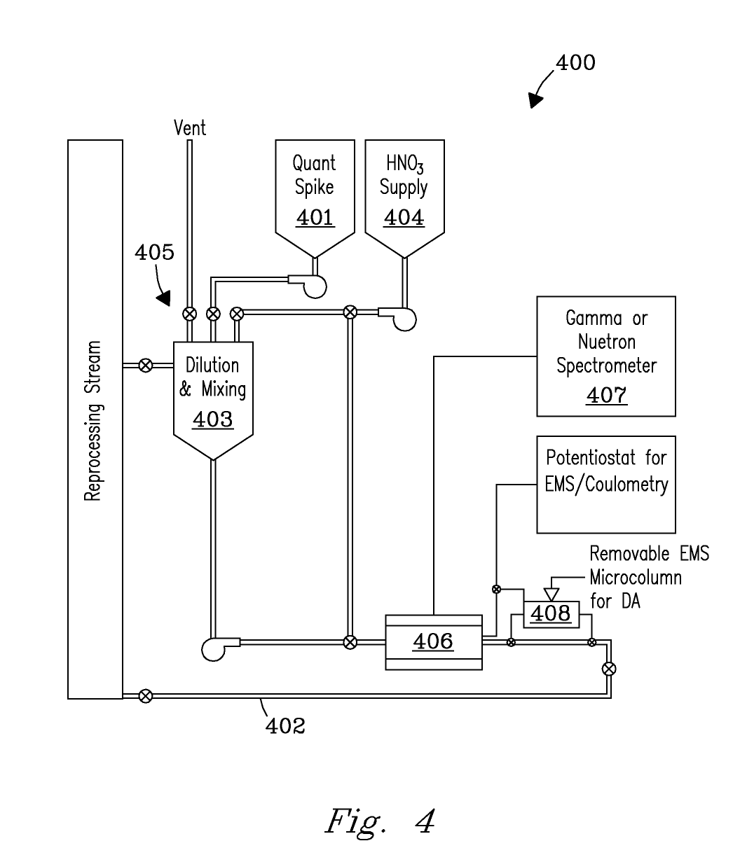

This experiment shows low-level environmental analytical applications where it is necessary to concentrate the actinide elements and eliminate salts to waste. The accumulation electrode can be rinsed free of contaminants and then stripped back off into a clean solvent (HNO₃) for analysis. Additionally, some actinides such as U can be accumulated, but at a negative potentials −0.15V, with release occurring at positive voltages. Referring to FIG. 3, two plots of U isotope mass signals as a function of time are shown for U in undiluted seawater at different scales. In this case, only the release step (U signal vs. time) is shown because the high salt content is detrimental to the ICP-MS. Salts and other metals are not readily accumulated. The technique is highly specific. In preliminary experiments, using solutions containing over 70 elements, only six elements (S, Pd, Ru, Sb, Tl, Bi) were found to co-deposit with Pu. In similar studies with U, only Mo, W, and Ce showed strong co-deposition among seven co-depositing elements. U and Pu were efficiently separated in these multi-element mixtures.

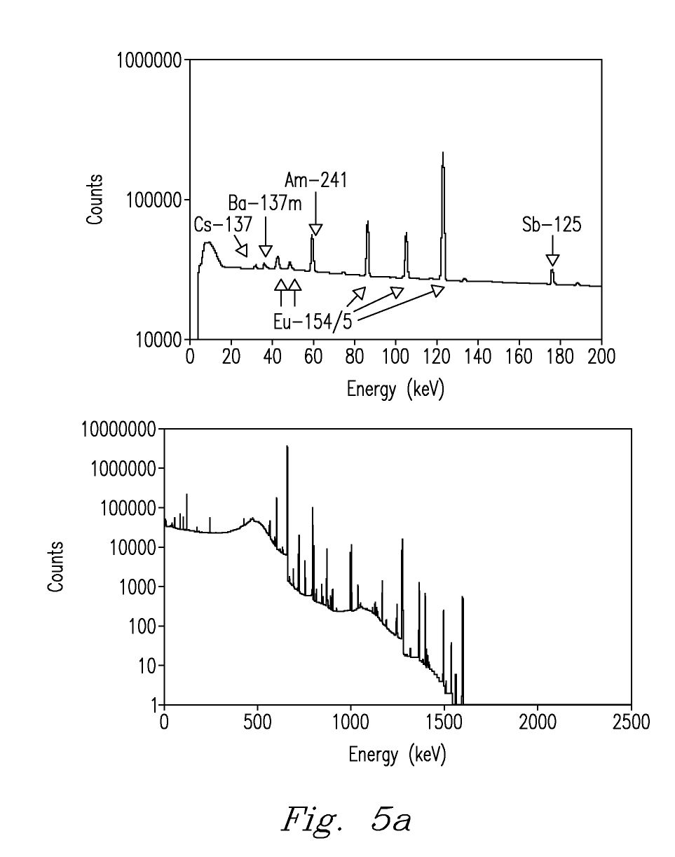

Another embodiment 400 is depicted in the illustration in FIG. 4. A porous graphitic carbon-based electrochemical cell, such as those described elsewhere herein, is envisioned for use in a chicane flow path 402 that returns to the process flow stream. Nitric acid rinse 404 and tracer spiking 401 can be readily addressed with a process manifold 405. In this approach one would selectively extract a target actinide (e.g., Pu) from the chicane stream, valve off this stream and dilute with clean nitric acid (plus a Pu spike to a known volume for quantification) into the mixing volume 403, accumulate at the anodized carbon surface 406, rinse, perform in-line analysis (e.g., gamma-ray spectroscopy) to indicate not only the total elemental concentration in the isolated diagnostic sample, but also the isotopic mixture (e.g., ²³⁹Pu, ²⁴¹Pu, ²⁴⁰Pu), strip material back into the stream, and then repeat the measurement with high periodicity to improve temporal resolution relative to destructive analysis. Various cell configurations are possible, with the primary objective of increasing the carbon surface area and cell volume to maximize the quantity and efficiency of separations.

Selective microsampling 408 for destructive analysis can be performed using a similar approach, with the concentrated analyte content stripped into a clean small volume solution for analysis. Microvolume sample handling techniques are currently employed and are readily adaptable to process streams. The quantity sampled is controlled by deposition time and concentration. Deposition substrates will be structured for facile sample introduction and extraction. These can be readily stripped off into a clean laboratory solution or directly into the sample stream of an inductively coupled plasma mass spectrometer.

To test the EMS-NDA system, a surrogate dissolver solution was prepared and tested in an EMS cell with decontamination factors measured via EMS-ICP mass spectrometry. The diluted sample maintained the relative concentrations shown in Table 1.

TABLE 1
Contents of spent nuclear fuel (1 metric ton of PWR fuel (~2 fuel
assemblies) from 50 MWd/kg burn-up after 10 years cooling).

| Element | Amount (kg) | | Element | Amount (kg) | |
|---|---|---|---|---|---|
| U | 936.0 | | Lanthanides | 15.3 | |
| Pu | 9.1 | | Xe | 8.2 | |
| Am | 1.3 | | Zr | 5.6 | |
| Np | 1.1 | | Mo | 5.2 | |
| Cm | 0.2 | | Ru | 3.4 | |
| Actinides | 947.7 | kg | Cs | 3.3 | |
| | | | Ba | 3.1 | |
| | | | Pd | 2.4 | |
| | | | Sr | 1.2 | |
| | | | Tc | 1.2 | |
| | | | Te | 0.71 | |
| | | | Y | 0.7 | |
| | | | Rb | 0.54 | |
| | | | Kr | 0.53 | |
| | | | Rh | 0.5 | |
| | | | I | 0.36 | |
| | | | Fission Products | 52.2 | kg |

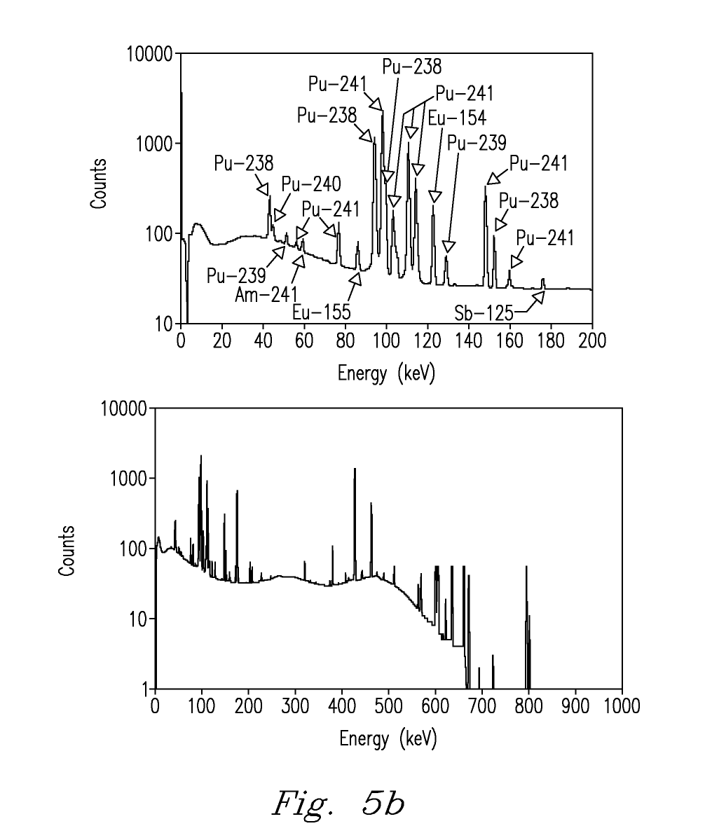

Gamma spectra before and after Pu isolation were simulated using the SYNTH model and the spectra are shown in FIGS. 5a and 5b. The spectrum in FIG. 5a is of the dissolver solution without any separation via EMS, and the spectrum in FIG. 5b is of the solution after EMS. These were modeled base on experimentally determined decontamination factors.

To arrive at the activities underlying the spectra, a dissolver solution concentration of 1.21M uranyl nitrate was assumed and published activities from a PWR 10-year-cooled fuel were used. The nuclide concentrations were then reduced based on the decontamination factors (an increase for Pu and Zr due to a concentration enhancement). Then all nuclide activities were input to SYNTH to produce representative spectra (30% HPGe detector and a 1-hour count).

The results suggest that Pu is detectable by gamma spectroscopy following EMS separation and accumulation of Puin the dissolver solution. The spectrum for the dissolver solution by itself shows that none of the peaks attributed to Pu can be observed. Following EMS, the background continuum drops almost 3 orders of magnitude and allows a number of Pu isotopes to be detected.

While various preferred embodiments of the invention are shown and described, it is to be distinctly understood that this invention is not limited thereto but may be variously embodied to practice within the scope of the following claims. From the foregoing description, it will be apparent that various changes may be made without departing from the spirit and scope of the invention as defined by the following claims.

We claim:

1. A method for monitoring target actinides in a fuel reprocessing or waste remediation facility, the method characterized by the steps of:
Providing a fuel reprocessing or waste remediation stream comprising at least one target actinide and at least one other radionuclide;
Flowing at least a portion of the stream through an electrochemically modulated separations (EMS) device comprising a carbon-based electrode;
Applying a potential to the carbon-based electrode to adjust the redox states of the target actinide, at least one of the radionuclides, or both;
Separating the target actinide from the other radionuclides through reaction with, or at, the carbon-based electrode;
Performing direct, in-line chemical nondestructive analysis, at-line chemical separations and sampling analysis, or both, of the target actinide.

2. The method of claim 1, wherein the target actinide is U or Pu and one of the other radionuclides comprises Pu or U, respectively.

3. The method of claim 1, wherein the target actinide comprises Pu, the stream comprises fission products, actinide products and greater than 0.1% dissolved solids, and said separating provides a greater than 95% retention of Pu.

4. The method of claim 1, wherein the other radionuclides comprise ¹³⁷Cs, ^{137m}Ba, or ^{154,155}Eu and are rejected at a rejection factor greater than 98%.

5. The method of claim 1, wherein the target actinide comprises Pu, at least one of the other radionuclides comprises U, and there is greater than 10 million fold excess uranium.

6. The method of claim 1, wherein at least one of the other radionuclides comprises ¹²⁵Sb, which is rejected at a rejection factor greater than 75%.

7. The method of claim 1, wherein no other separations are performed prior to the direct, in-line chemical nondestructive analysis, the at-line chemical separations and sampling analysis, or both, of the target actinide.

8. The method of claim 1, wherein the carbon-based electrode comprises porous graphitic carbon electrodes.

9. The method of claim 1, wherein the carbon-based electrode comprises reticulated vitreous carbon.

10. The method of claim 1, wherein the carbon-based electrode comprises glassy carbon fibers.

11. The method of claim 1, wherein the carbon-based electrode has an active carbon surface area greater than 5 cm².

12. The method of claim 1, wherein the direct in-line chemical nondestructive analysis, the at-line chemical separations and sampling analysis, or both, comprises gamma ray spectroscopy.

13. The method of claim 1, wherein the direct in-line chemical nondestructive analysis, the at-line chemical separations and sampling analysis, or both, comprises neutron spectroscopy.
